(19) United States
(12) Patent Application Publication
(10) Pub. No.: US 2011/0179445 A1
(43) Pub. Date: Jul. 21, 2011

(54) TARGETED ADVERTISING BY CONTEXT OF MEDIA CONTENT

(76) Inventors: William Brown, Cumming, GA (US); Chris Phillips, Hartwell, GA (US)

(21) Appl. No.: 12/691,026

(22) Filed: Jan. 21, 2010

(51) Int. Cl. H04N 7/10; G06Q 30/00

(52) U.S. Cl. 725/32; 705/14.49

(57) ABSTRACT

A computer-controlled system and method for inserting real-time targeted advertising in media content such as a video stream based upon contextual information occurring in the video stream. The system detects and extracts contextual information such as subtitles, closed captions, and tags associated with images in the video stream and then determines whether the contextual information is related to any advertisements in a database of advertisements. The contextual information may be utilized together with other advertising criteria and audience qualifiers to prioritize the advertisements for automatic insertion at the next advertising splice point.

### CROSS-REFERENCE TO RELATED APPLICATIONS

NOT APPLICABLE

### STATEMENT REGARDING FEDERALLY SPONSORED RESEARCH OR DEVELOPMENT

NOT APPLICABLE

### REFERENCE TO SEQUENCE LISTING, A TABLE, OR A COMPUTER PROGRAM LISTING COMPACT DISC APPENDIX

NOT APPLICABLE

### BACKGROUND

The present invention relates to multimedia delivery systems. More particularly, and not by way of limitation, the present invention is directed to a system and method for automatically inserting targeted advertising material in media content based at least in part on contextual information extracted from the media content.

For many years, multimedia content such as television programming was distributed to viewers only by broadcasting radio frequency signals through the air. Over time, new delivery mechanisms such as cable TV, satellite 11/, video-on-demand (VOD) systems, and the Internet have emerged. Regardless of the delivery mechanism, the cost of producing and distributing the content has traditionally been covered by selling advertising space at designated points in the programs.

Over the years, advertisers have looked for ways to more closely target their advertising to the viewers anticipated to be watching at the time the commercials are shown. For example, advertisers might purchase advertising space during a particular program often viewed by large numbers of their target audience. Beer and sports car commercials, for example, might be run during a football game in order to reach a target male audience. Today, advertisers are examining new ways of reaching their target audiences as operators attempt to deliver more relevant and interactive ads to their subscribers.

Ads are inserted into the media content by advertising insertion systems. Current advertising insertion systems enable media providers to insert/replace advertisements in the media content at predefined insertion points as defined by the provider of the content. Current ad insertion systems provide for the use of advertising campaigns, which target ads by matching advertising criteria and audience qualifiers. Ads may be inserted based on viewing characteristics, prior purchase transactions, demographics, video selection, or some combination thereof. This process of targeting the ad to the audience is still largely a manual process.

### BRIEF SUMMARY OF THE INVENTION

Current advertising insertion systems have several shortcomings. First, the process of matching advertising criteria and audience qualifiers does not take into account the context within which the ad is placed, other than the genre or title of the program within which the ad is shown. Second, the manual process of targeting the ad is too cumbersome and too slow for real-time ad insertion.

It would be useful to have a system and method that more accurately targets advertising by considering in the ad-selection decision, what is shown and/or said in a program prior to an ad insertion splice point. Such a system and method may provide additional weight to specific contextual information that occurs within a predefined time period prior to a commercial break. It would also be useful to have a system and method that is fully automatic so that contextual information within a few seconds of the commercial break can be considered in the ad-selection decision. The present invention provides such a system and method.

The present invention provides an automated system and method for inserting real-time target advertising in media content based on the context of the viewing and/or listening experience at the time of ad insertion. In one embodiment, the invention utilizes information such as position-relative closed captioning information, subtitle information, and/or position-relative product placement information as additional targeting information for use in a dynamic ad decision selection process.

Thus, in one embodiment, the present invention is directed to a computer-controlled method of inserting real-time targeted advertising in media content. The method includes the steps of detecting contextual information within the media content; determining whether the contextual information is related to an advertisement in a database of advertisements; and upon determining that the contextual information is related to an advertisement in the database, automatically inserting a related advertisement at a splice point in the media content.

In a specific embodiment, the media content is a video stream, and the method includes detecting contextual information associated with the video stream, the contextual information comprising at least one of: specific words or phrases in subtitles accompanying the video stream; specific words or phrases in closed captions accompanying the video stream; and tags associated with images in the video stream. The method also includes determining whether the contextual information is related to an advertisement in a database of advertisements by determining whether the contextual information matches words or phrases associated with any of the advertisements in the database; and upon determining that the contextual information is related to at least one of the advertisements in the database, automatically inserting a related advertisement at a splice point in the video stream.

In another embodiment, the present invention is directed to an automated advertisement targeting system for inserting real-time targeted advertising in media content. The system includes a contextual information extractor for extracting contextual information from the media content; a matching unit for receiving the extracted contextual information and determining whether the extracted contextual information is related to any advertisements stored in a database of advertisements; and an advertisement insertion unit for automatically inserting at a splice point in the media content, at least one advertisement related to the extracted contextual information.

### BRIEF DESCRIPTION OF THE SEVERAL VIEWS OF THE DRAWING

In the following section, the invention will be described with reference to exemplary embodiments illustrated in the figures, in which:

FIG. 1 is a flow chart illustrating the steps of an exemplary embodiment of the method of the present invention;

FIG. 2 is an illustrative drawing illustrating an exemplary content sample suitable for use with the present invention; and

FIG. 3 is a simplified block diagram of an exemplary embodiment of the ad targeting system of the present invention.

### DETAILED DESCRIPTION OF THE INVENTION

The context-sensitive advertising system and method of the present invention enables advertisers to insert ads based on the context of the viewing experience at the time of ad insertion. In one embodiment, the dynamic advertising system inserts advertising based on the subject matter of the dialog between two actors. For example, when the actors discuss the performance capabilities of the Chevrolet Corvette just before an ad break, the dynamic advertising system uses this information at the point of ad insertion to place a higher weighting on a Chevrolet Corvette commercial than on other possible commercial selections. In another embodiment, the dynamic advertising system may insert advertising based on the existence of product placements in the content. For example, when an Apple computer is visible in a scene just prior to an ad break, the dynamic advertising system uses this information at the point of ad insertion to place a higher weighting on an Apple commercial than on other possible commercial selections.

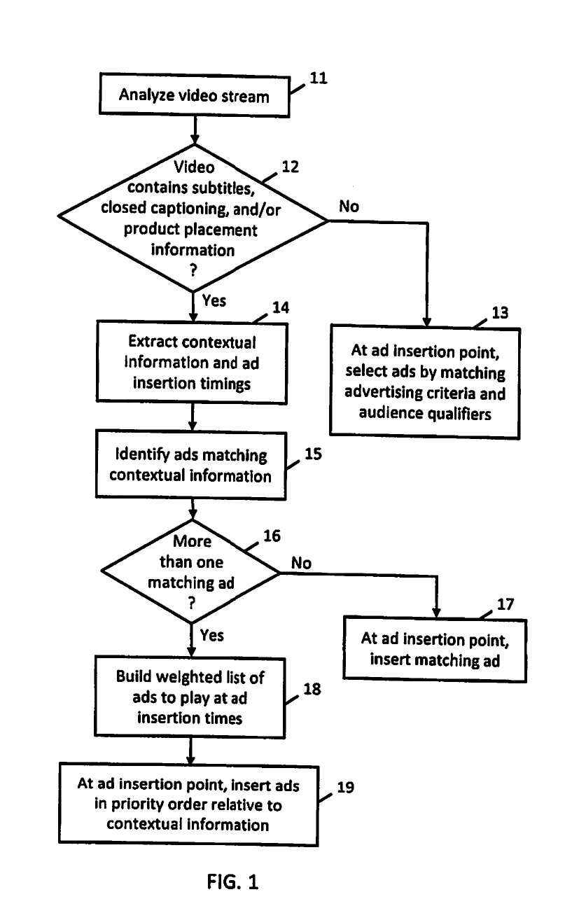

FIG. 1 is a flow chart illustrating the steps of an exemplary embodiment of the method of the present invention. A video stream may be distributed from a source by means of terrestrial broadcast, satellite broadcast, cable television network, or other suitable distribution mechanism. At step 11, the video stream is analyzed for characteristics suitable for use in real-time targeting of advertising. At step 12, it is determined whether the video stream contains usable contextual information such as, for example, subtitles, closed-captioning information, and/or product placement information. The contextual information may be included in one or more separate data streams or tracks sent along with the video and audio portions of the video stream. The term “product placement information” refers to brand-name products that are visible and identifiable in scenes within the video content. Tags identifying the brand-name products may be embedded with the subtitles or closed-captioning information, or may be multiplexed on another concurrent data stream.

If the video stream does not include any usable contextual information, the method moves to step 13 where conventional methods of selecting ads by matching advertising criteria and audience qualifiers are utilized to insert ads at the ad insertion points. However, if the video stream includes any usable contextual information, the method moves to step 14 where the contextual information is extracted along with SCTE-35 advertising insertion timings. The Society of Cable and Telecommunications Engineers (SCTE) develops and publishes standards used in cable transmissions. SCTE-35 provides mechanisms for signaling the availability of local interstitial availabilities (such as local commercial messages) in national or regional cable television programming. SCTE-35 is colloquially referred to as “cue tones” because it is a digital equivalent of analog cue-tones that were previously common in analog feeds of U.S. cable networks. The signaling mechanisms in SCTE-35 provide for reserving bandwidth, signaling splicing points in MPEG-2 program services, and associated functionality. The SCTE-35 standard is incorporated herein by reference in its entirety.

At step 15, logic is applied to the extracted contextual information to determine whether the contextual information is related to any advertisements stored in a database of advertisements. When the contextual information matches a stored ad, the ad is targeted for insertion at one or more of the ad insertion points, depending on the advertiser's preferences. At step 16, it is determined whether there is more than one ad that matches the contextual information. If not, i.e., only one ad matches, the method moves to step 17 where the matching ad is inserted at the ad insertion point. If more than one ad matches the contextual information, the method moves to step 18 where a weighted list of ads is built. Various weights may be assigned to each ad in order to prioritize the ads on the list for insertion at an identified insertion point. For example, additional weight may be given to products that are mentioned or shown several times, or are mentioned or shown closer in time to the ad insertion point. For example, when the actors discuss the performance capabilities of the Chevrolet Corvette just before an ad break, this information may be utilized at the point of ad insertion to place a higher weighting on a Chevrolet Corvette commercial than on other possible commercial selections. At step 19, the matching ads are inserted at the insertion point in priority order relative to the contextual information.

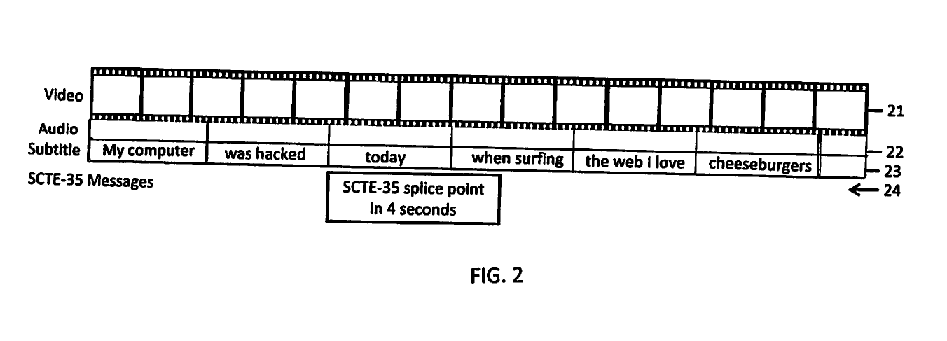

FIG. 2 is an illustrative drawing illustrating an exemplary content sample suitable for use with the present invention. The content sample includes a video portion 21, an audio portion 22, subtitle text 23, and SCTE-35 messages 24. In the illustrated example, the SCTE-35 message indicates that a splice point occurs in four (4) seconds. In this example, the subtitle text indicates that an actor says that his computer was hacked today while surfing the web. He also mentions that he loves cheeseburgers. These statements occur within a few seconds of the SCTE-35 splice point. In this instance, if there are ads in the database for such products as antivirus software and/or a hamburger restaurant, the invention will match the subtitle text with the appropriate ads and insert the ads at the upcoming splice point.

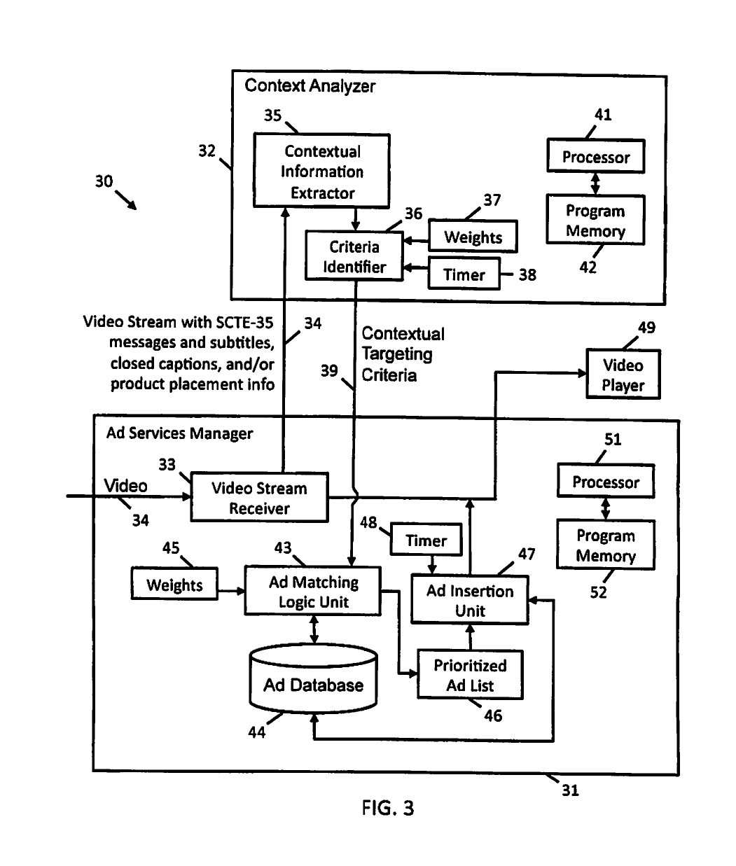

FIG. 3 is a simplified block diagram of an exemplary embodiment of the ad targeting system 30 of the present invention. For simplicity, only those components of a video distribution network necessary for describing the present invention are shown, although those skilled in the art will readily understand that components such as national and/or regional data centers, video servers, digital services platforms, set top boxes, and the like are utilized to deliver the video signal to the present invention and to propagate the video signal to the end user.

In the illustrated embodiment, the system includes an Ad Services Manager 31 and a Context Analyzer 32. A video stream receiver 33 in the Ad Services Manager receives a video stream 34 and provides the stream to a contextual information extractor 35 in the Context Analyzer. The video stream may include SCTE-35 messages indicating the timing until the next advertising insertion point, as well as contextual information such as subtitles, closed captions, and/or position-relative product placement information. The video stream is provided to a user's video player 49 while the contextual information extractor 34 extracts the subtitles, closed captions, and/or product placement information. The extracted contextual information and SCTE-35 messages are provided to a criteria identifier 36, which utilizes configurable weighting criteria 37 and timer information 38 to develop contextual targeting criteria 39. The weighting criteria may include, for example, the mentioning of a product by the actors in the video, the number of times the product is mentioned or shown, the total time that a product is mentioned or shown, and the proximity to the advertising insertion point when the product is mentioned or shown. Weights may also be applied depending on the degree of specificity with which a product is mentioned. For example, increasing weights may be applied depending on whether an actor mentions a motor vehicle, a car, a sports car, or a Corvette. The timer 38 enables the criteria identifier 36 to determine the total time that a product is mentioned or shown and/or the proximity to the advertising insertion point when the product is mentioned or shown. The operation of the Context Analyzer 32 may be controlled by a processor 41 running computer program instructions stored on a program memory 42.

Once the criteria identifier 36 has identified the contextual targeting criteria 39, they are sent to an ad matching logic unit 43 in the Ad Services Manager 31. The ad matching logic unit may use, for example, artificial intelligence (AI) logic to match words and/or phrases in the contextual information with information associated with advertisements stored in an ad database 44. Although depicted as being internal to the Ad Services Manager 31, it should be understood that the ad database may be implemented external to the Ad Services Manager in some embodiments.

The ad matching logic unit 43 may also receive configurable weighting criteria 45 as inputs for the ad matching process. The weighting criteria 45 may include the network owner of the next ad break, the program or genre of the program being shown, the time of day, the day of the week, the target audience, and other advertising criteria and audience qualifiers. The contextual targeting criteria 39 together with the weighting criteria 45 are used to determine the priority of ads placed in a prioritized ad list 46. The prioritized ad list is provided to an ad insertion unit 47. The ad insertion unit receives an input from a timer 48, and at the time of the SCTE-35 splice point, retrieves ads from the ad database 44 in priority order and inserts the ads in the video stream as it is being provided to the user's video player 49. When the ads have played and the ad break is over, the video stream resumes and is again provided from the video stream receiver 33 to the video player 49. The operation of the Ad Services Manager 31 may be controlled by a processor 51 running computer program instructions stored on a program memory 52.

As will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims.

What is claimed is:

1. A computer-controlled method of inserting real-time targeted advertising in media content, said method comprising the steps of:
detecting contextual information within the media content;
determining whether the contextual information is related to an advertisement in a database of advertisements; and
upon determining that the contextual information is related to an advertisement in the database, automatically inserting a related advertisement at a splice point in the media content.

2. The method according to claim 1, wherein the contextual information comprises subtitles accompanying a video stream, and the step of determining whether the contextual information is related to an advertisement includes determining whether specific words or phrases in the subtitles match words or phrases associated with any of the advertisements in the database.

3. The method according to claim 1, wherein the contextual information comprises closed-captions accompanying a video stream, and the step of determining whether the contextual information is related to an advertisement includes determining whether specific words or phrases in the closed-captions match words or phrases associated with any of the advertisements in the database.

4. The method according to claim 1, wherein the contextual information comprises tags associated with images in a video stream, and the step of determining whether the contextual information is related to an advertisement includes determining whether any of the tags match words or phrases associated with any of the advertisements in the database.

5. The method according to claim 1, further comprising prioritizing the advertisements related to the contextual information when more than one advertisement is related to the contextual information.

6. The method according to claim 5, wherein the step of prioritizing the advertisements includes providing additional weight to contextual information occurring within a predefined time period before the splice point.

7. The method according to claim 5, wherein the step of prioritizing the advertisements includes providing additional weight to contextual information each time the contextual information occurs in the media content prior to the splice point.

8. The method according to claim 5, wherein the step of prioritizing the advertisements includes providing additional weight to contextual information in proportion to the total time the contextual information occurs in the media content prior to the splice point.

9. The method according to claim 5, wherein the step of prioritizing the advertisements includes providing additional weight to contextual information in proportion to the degree of specificity with which the contextual information relates to a specific product.

10. The method according to claim 1, wherein the step of automatically inserting the related advertisement at a splice point in the media content includes automatically inserting the related advertisement at the next Society of Cable and Telecommunications Engineers (SCTE)-35 splice point following the occurrence of the contextual information.

11. The method according to claim 1, wherein the media content is broadcast video having an accompanying track in which the contextual information is located.

12. The method according to claim 1, wherein the media content is a video stream distributed over a cable television network, the video stream having an accompanying track in which the contextual information is located.

13. The method according to claim 1, wherein the media content is a video-on-demand (VOD) stream, the VOD stream having an accompanying track in which the contextual information is located.

14. A computer-controlled method of inserting real-time targeted advertising in a video stream, said method comprising the steps of:
detecting contextual information associated with the video stream, the contextual information comprising at least one of:
specific words or phrases in subtitles accompanying the video stream;
specific words or phrases in closed captions accompanying the video stream; and
tags associated with images in the video stream;
determining whether the contextual information is related to an advertisement in a database of advertisements by determining whether the contextual information matches words or phrases associated with any of the advertisements in the database; and
upon determining that the contextual information is related to at least one of the advertisements in the database, automatically inserting a related advertisement at a splice point in the video stream.

15. The method according to claim 14, wherein the video stream is one of:
a terrestrial broadcast video stream;
a satellite broadcast video stream; and
a video stream distributed over a cable television network.

16. The method according to claim 15, wherein the video stream is a video-on-demand (VOD) video stream.

17. An automated advertisement targeting system for inserting real-time targeted advertising in media content, said system comprising:
a contextual information extractor for extracting contextual information from the media content;
a matching unit for receiving the extracted contextual information and determining whether the extracted contextual information is related to any advertisements stored in a database of advertisements; and
an advertisement insertion unit for automatically inserting at a splice point in the media content, at least one advertisement related to the extracted contextual information.

18. The device according to claim 17, wherein the contextual information comprises at least one of subtitles accompanying a video stream, closed-captions accompanying the video stream, and tags associated with images in the video stream.

19. The device according to claim 18, further comprising:
a timer for measuring a time period from the occurrence of a piece of contextual information related to an advertisement until the next splice point; and
means for prioritizing different pieces of contextual information, wherein a piece of contextual information is given greater weight when the piece of contextual information occurs within a predefined time period before the splice point.

20. The device according to claim 19, wherein the matching unit also includes means for prioritizing advertisements for insertion in the video stream at the splice point utilizing the prioritized contextual information together with advertising criteria and audience qualifiers.

21. The device according to claim 17, wherein the wherein the media content comprises one of:
a broadcast video having an accompanying track in which the contextual information is located;
a video stream distributed over a cable television network, the video stream having an accompanying track in which the contextual information is located; and
a video-on-demand (VOD) stream, the VOD stream having an accompanying track in which the contextual information is located.
